(19) United States
(12) Patent Application Publication
(10) Pub. No.: US 2001/0021013 A1
(43) Pub. Date: Sep. 13, 2001

(54) Device for testing and/or measurement of test samples

(76) Inventors: Walter Hecht, Ravensburg (DE); Volker Jauch, Baienfurt (DE); Andreas Knam, Weingarten (DE)

Correspondence Address: William D. Breneman, Esq., BRENEMAN & GEORGES, 3150 Commonwealth Avenue, Alexandria, VA, 22305, US

(21) Appl. No.: 09/803,912

(22) Filed: Mar. 13, 2001

(30) Foreign Application Priority Data
Mar. 13, 2000 (DE) 100 11 318.4

(51) Int. Cl. G01B 11/04

(52) U.S. Cl. 356/51

(57) ABSTRACT

A device (1) for the inspection and/or measurement of objects by means of an image processing apparatus is provided, whereby the objects to be checked are laying on a transport belt (2) and are recorded by process of transillumination. The device constructed in accordance with the invention can be produced more inexpensively while causing less disturbance to persons located in the vicinity of the device because of light effects. According to the invention this is accomplished by the illumination unit comprising at least one infrared light source (5).

### BACKGROUND OF THE INVENTION

1. Field of the Invention

The invention pertains to a device for inspection and/or measurement of objects. More particularly the invention provides an image processing apparatus utilizing an infrared light source for illuminating test objects.

2. Description of Related Art Including Information Disclosed Under 37 CFR 1.97 and 1.98

Previously known devices for the inspection and/or measurement of objects recorded an image of an object in a free flight or a sliding motion on a transparent glide track. Such devices present the problem of objects having to move within a defined position in front of the image camera. Furthermore an appropriately cumbersome mechanism is required to advance objects individually in front of the camera.

More recently efforts have been undertaken to create transport belts transparent within the visible range, so that a transillumination of the transport belt within the visible range is made possible and thus an image recording can be made of the object resting on the transport belt.

Because of the small scale manufacture of such customized transport belts they can only be obtained at a relative cost expenditure. Furthermore the illumination of such apparatus is disturbing, especially when image recording is done in a strobe light operation, in which constant operation results in stroboscopic lighting, which is tolerated as a disturbance by persons in the vicinity of the device.

### BRIEF SUMMARY OF THE INVENTION

In contrast to the prior art the invention has an object of providing a device that can be manufactured more inexpensively and which in turn does not cause unpleasant side effects for persons within the vicinity of the apparatus. This object is accomplished by the type of device mentioned preliminarily heretofore by the use of infrared light for illuminating the test objects. In the preferred applications and embodiments of the invention the camera is designed to operate in the specific light bandwidth frequency of the light source and filters are employed to permit only infrared light into the camera. Additional advantages may be achieved utilizing a diffusor which may be integrated into the transport belt. This may be accomplished by providing a textured layer which can be a polyamide texture or transport layer. The transport belt may be a single or multiple transport belts that are disposed angularly to each other or inclined with respect to the horizontal or bent during operation to form a V- or L-shape to hold test objects of an irregular shape. The infrared light source may be infrared light emitting diodes or IR-LED lights. Consequently devices constructed in accordance with the invention are characterized by an illumination unit comprising an infrared lighting source.

Infrared light lies outside the visible range and, as a result, even in a stroboscopic operation such light cannot be perceived as disturbing by persons within the vicinity of the device. Furthermore, it has been unexpectedly discovered that a large number of transport belts that are already commercially available in large scale permit infrared light to pass through. The utilization of infrared light therefore also makes the utilization of such commercially customary inexpensive transport belts possible, as a result the production cost can be significantly reduced for a device constructed in accordance with the invention.

In a preferred application of the invention a camera is utilized which is exclusively suited for the detection of infrared light emitted by the illumination unit. In this manner disturbances can be minimized. Such disturbances, for instance, can be existent in the form of daylight or room lighting. In as much as the frequency range of the light source is not captured by the camera, accordingly no disturbing signals can be caused.

A further advantageous possibility for minimizing disturbances consists of applying a filter in front of the camera that allows for infrared light to pass through. In such an application the above described disturbance from visible light can be minimized, even when utilizing a camera suited for a broad frequency band, such as those operating within the visible range.

In a further modification of the invention additionally a diffusor is provided between the illumination unit and the object. A diffusor provides for a homogeneous illumination of the object, to ensure that especially reflections and the casting of shadows are eliminated. An object illuminated with diffused light can be evenly captured over the entire area of its contours by the appropriate camera.

In a further modification of the invention the diffusor for the infrared light is provided by the transport belt. In this manner the necessity for a separate diffusor is eliminated. It has further been found that some commercially available transport belts can also sufficiently provide the function of a diffusor.

In a further preferred application a texture layer is provided in the transport belt. Such a texture layer can serve two kinds of functions. One of the functions provided by the texture is to accomplish the function of a diffusor, while at the same time the texture significantly improves the stress limitations or flex properties of a transport belt. As a result many commercially available transport belts have already provided for such texture layers.

In a special application of the invention the transport belt comprises a polyamide texture and at least one polyamide transport layer on the transport belt. A transport belt constructed in such a manner has already proven itself during testing for utilization in accordance with the invention. Such transport belts demonstrate a sufficient transmittance for the desired infrared light for the illumination of the objects while, at the same time, providing for sufficient diffused illumination. Furthermore, such transport belts with sufficient mechanical properties are commercially available.

Preferably for illumination one or more light diodes are utilized. The employment of a light diode has the particular advantage in combination with the infrared illumination chosen in accordance with the invention. Such infrared light diodes are available at comparable cost but provide a substantially higher power output than light diodes in the visible range. More particularly, the specific combination of infrared illumination utilizing a light diode is able to further reduce cost for the production for devices constructed in accordance with the invention.

Furthermore in a preferred application of the invention surface illumination for the illumination of objects is provided. Such surface illumination is preferably achieved by a so-called light diode array, which means several light diodes are arranged in one or more rows next to one another.

In a further modification of the invention two transport belts are utilized having transporting surfaces disposed to each other at a predetermined angle. This has the advantage of allowing objects with a ‘not-flat’ deposit surface, for instance, machined parts, to be deposited in a particular defined position. They are hereby positioned with their axis in between the angle-bisecting plane between the two angularly positioned transport belts.

In addition to a defined position of such objects with a “not-level” deposit surface, the angular arrangement as described of two transport belts can furthermore be utilized to illuminate objects from the side and to look onto objects from the side with the camera. Thus the objects are captured quasi in a suspended state by the camera, although they are being transported while at rest on the transport belts. As a result the camera is disposed to the axis of the objects at a view angle of 90°, so that the edges visible in this direction of projection can be measured.

A further means for achieving this viewing angle of the camera consists of bending the transport belt, or, as the case may be, providing two transport belts that are angled toward one another, in the direction of transport, so that the angle between the axis of the object and the direction of the camera is changed. As a result the desired image can be recorded at the moment when the angle is a right angle. This embodiment has the benefit that the camera can be arranged above the transport belt and thus no image recording has to take place through the transport belt.

In a further modification of this embodiment one level belt and two angled transport belts can be arranged in succession. In this manner objects with varied deposit surfaces can be placed onto the transport belt successively and be inspected with the aid of image capturing units. In such a way, for example, machined parts with a flat front side can at first be deposited onto the level transport belt, and the circumferential contours can be measured through a direction of view pointed vertically towards the transport belt. Subsequently such a machined part can be handed off to two transport belts that are angled towards one another, whereby the tilting is such that its circumferential surface rests on both transport belts. In this position the above cited side view of such a machined part can be recorded.

With appropriately flexible transport belts an arrangement might be provided, wherein a transport belt at first runs horizontal and subsequently is bent to form an inclined transport plane. In this manner with two parallel running transport belts one transport plane could be created initially, which then progresses into a V- or L-shape in the direction of transport.

In applications where the friction between objects and transport belt is not sufficient for a sufficiently stable position on the transport belt, and a so-called slip between transport belt and object occurs, the transport belt in the preferred application may be slightly inclined in relation to direction of transport, to counteract such a slip.

One such application of the invention is illustrated in the drawings and subsequently will be explained in greater detail with the aid of the Figures.

### BRIEF DESCRIPTION OF THE SEVERAL VIEWS OF THE DRAWINGS

In detail it is depicted in:

FIG. 1 is a side view schematic illustration of a device constructed in accordance with the invention,

FIG. 2 is an image recording of an object made by a device constructed in accordance with the invention,

FIG. 3 is an embodiment of a transport belt constructed in accordance with the invention and

FIG. 4 is a further embodiment of a transport belt.

### DETAILED DESCRIPTION OF THE INVENTION

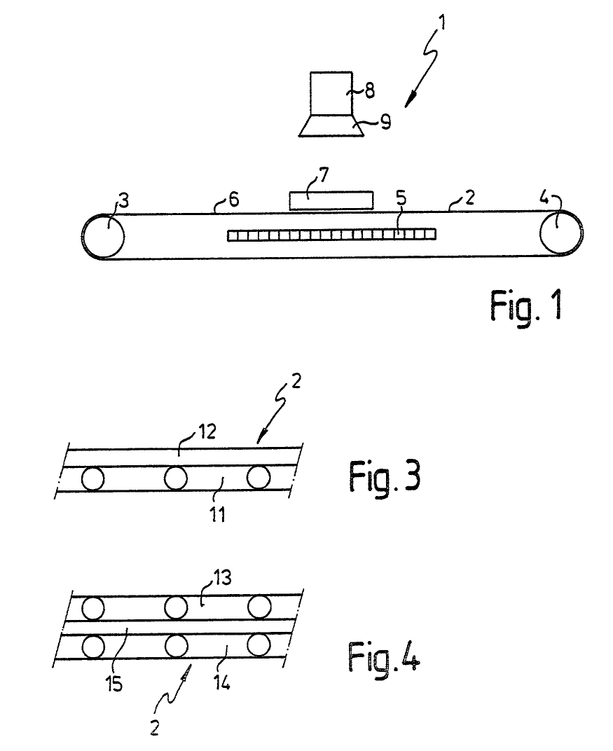

The device 1 as illustrated in FIG. 1 comprises a transport belt 2, which continuously travels around two rollers 3, 4. Disposed between the transport belt is an illumination unit in the form of an LED (light emitting diode) array 5. The LED array 5 provides for a planar illumination of the upper area 6 of transport belt 2.

On transport belt 2, or as the case may be, its upper area 6 an object 7 has been deposited. Object 7 is illuminated as it is guided above and straight past LED array 5.

A camera 8 with a lens 9 is disposed above the object which in the present position of the object 7 (as illustrated in FIG. 1) is thus able to record an image of the object 7. The camera 8, or the lens 9 may advantageously utilize a filter allowing infrared light to pass through, so that only light of infrared LED array 5 is captured, so that peripheral light will not influence the image recording.

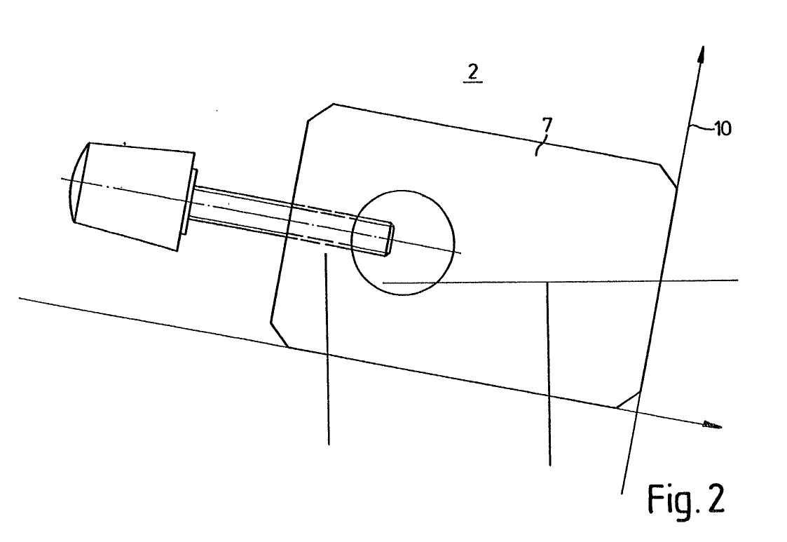

In FIG. 2 it can be recognized that in this manner an object 7 having sharp contours can be captured at rest on transport belt 2. Diverse reference lines 10 have already been applied to object 7 by the analyzer unit of the image processing apparatus to accomplish a measurement.

FIG. 3 illustrates one possible configuration of a transport belt 2 constructed in accordance with the invention. The transport belt 2 comprises a texture layer 11, which is covered by a transport layer 12. At least one of the two layers 11, 12 is preferredly constructed as diffusor. Generally this is accomplished by texture layer 11.

FIG. 4 shows a further embodiment of a transport belt 2 constructed in accordance with the invention, in which however two texture layers 13, 14, are arranged to provide a sandwich like enclosure for homogenous layer 15. Homogeneous layer 15 can thereby be equipped with appropriate functional properties, which, for example, provide for the function of diffusing. A reverse scenario, which will not be explained in greater detail, can also be provided, in which multiple texture layers 11, 13, 14 are encompassed sandwich like by two outer layers similar to transport layer 12 or homogenous layer 15.

In accordance with the invention an inexpensive image processing inspection and measuring apparatus is provided. This is essentially achieved through the utilization of infrared light, which is surprisingly compatible with some commercially available transport belts. It had been presumed that specific transparent transport belts would have had to be constructed in view of the developmental history of such measuring and inspection devices in which the object rests on the transport belt.

Furthermore, the utilization of infrared light, as has heretofore been repeatedly mentioned, offers the additional advantage that persons in the vicinity of the apparatus will not be disturbed by the perceived illumination of objects.

In the preceding specification the following reference numbers have been used to describe the invention as illustrated in the drawings in the following Reference List:

### REFERENCE LIST

1 Device

2 Transport belt

3 Roller

4 Roller

5 LED Array

6 Upper area

7 Object

8 Camera

9 Lens

10 Reference line

11 Texture layer

12 Transport layer

13 Texture layer

14 Texture layer

15 Homogenous Layer

What is claimed is:

1. Device for inspection and/or measurement of objects by means of an image processing apparatus, whereby a transport belt with a deposit surface for receipt and transport of the objects as well as providing an illumination unit on the opposite side for the transillumination of the transport belt and the utilization of a camera directed at the objects that are positioned on the transport band, characterized whereby the illumination unit (5) comprises an infrared light source.

2. Device according to claim 1 characterized whereby the camera 8 is adapted to the bandwidth frequency of the light source.

3. Device according to one of the previous claims characterized whereby a filter permitting infrared light to pass through is located in front of the camera (8).

4. Device according to one of the previous claims characterized whereby by providing a diffusor.

5. Device according to one of the previous claims characterized whereby the diffusor is integrated into the transport belt.

6. Device according to one of the previous claims characterized whereby the transport belt comprises at least one texture layer (13) and a transport layer (14).

7. Device according to one of the previous claims characterized whereby a polyamide texture layer and/or a polyamide transport layer is provided in the transport belt.

8. Device according to one of the previous claims characterized whereby an illumination unit comprises at least one IR-LED (5).

9. Device according to one of the previous claims characterized whereby the illumination unit comprises an LED array (5).

10. Device according to one of the previous claims characterized whereby two transport belts are angularly arranged.

11. Device according to one of the previous claims characterized whereby a level transport belt and two transport belts that are angled toward one another are arranged in succession.

12. Device according to one of the previous claims characterized whereby the level transport belt is designed as isolation unit on the way towards two angled belts.

13. Device according to one of the previous claims characterized whereby at least one transport belt is inclined to the horizontal plane in the direction of transport to compensate for a possible slip of an object on the transport belt.
